(19) United States
(12) Patent Application Publication
(10) Pub. No.: US 2006/0148488 A1
(43) Pub. Date: Jul. 6, 2006

(54) Method for handling location data

(76) Inventor: Hanno Syrbe, Weidstetten (DE)

Correspondence Address: PERMAN & GREEN, 425 POST ROAD, FAIRFIELD, CT, 06824, US

(21) Appl. No.: 10/539,170

(22) PCT Filed: Dec. 27, 2002
(86) PCT No.: PCT/EP02/14776

§ 371 Date: Dec. 30, 2005

(51) Int. Cl. H04Q 7/20

(52) U.S. Cl. 455/456.1; 455/550.1

(57) ABSTRACT

A method, a device and an application for creating a collection of selected geographical positions that have been visited by the device. The mobile terminal has a geographical position system and a memory for containing the collection of selected geographical positions. A current position of interest is obtained or determined by the terminal's positioning system and stored in the memory upon a user input. The stored geographical positions can be provided with attributes such as names and categories. Mobile terminals can exchange stored geographical positions via cable. IR, RF or cellular communication. A collection of geographical positions can be subjected to statistical and probability analysis, and a map can be generated to visualize the results of the analysis.

The present invention relates generally to handling of geographical locations and more particularly to a method, an application and a device for creating a collection of selected geographical positions that have been visited by the device.

### BACKGROUND ART

U.S. Pat. No. 6,459,987 discloses a method for automatically generating a backtrack route, using the aid of Global Positioning System technology. The method records a series of data points along a traversed route. The data is used for backtrack navigation.

U.S. Pat. No. 6,477,461 discloses a navigation system for vehicles that has a rewritable memory which stores data of a plurality of locations, and searches the rewritable memory for a target location for use in guiding a travel route. Users can input a new location for registration manually by specifying a new location on a map. The data of a new location is stored in the rewritable memory in addition to original data of the plurality of locations. When a user requests a search for the target location by a name of the target location, the navigation system searches it alphabetically by referring to both data of the plurality of locations and the new location. The navigation system can also conduct the location search by a facility type.

GB 2 370 708 discloses a vehicle based system for capturing and using information associated with geographic locations of interest to a user. The vehicle based system is in communication with a remote apparatus. The mobile apparatus accepts and transmits information associated with a mobile user's geographic position. The remote apparatus receives the transmitted information, stores the information along with data indicative of the position and time as a waypoint, and allows the user to retrieve and manipulate waypoints. The user can assign descriptive information such as a voice tag, voice message or picture to the stored geographical positions. This system requires intensive communication between the vehicle based system and the remote apparatus, adding to the cost of operation and cannot operate when the mobile apparatus cannot reach the remote apparatus. Further, the system requires a position system to provide geographical to the vehicle based system.

WO 0 101 295 discloses a method to create information objects relating to a geographical place. A first user at a laptop computer can make/place an indication, a footprint, related to a geographical position and store the indication by means of a remote service server, which is accessible on an open computer network, such as Internet. By the computer network also others have access to the footprint. The footprint indicates a place of interest and can be registered so that it can be seen only by the one who has made/placed it, by all within a certain group, or be entirely public. The information then can be shown to the same user, or others, on a map on a display of a computer, at which position of current interest and icons appear on the map when the laptop computer is moved. Associated with the icons there also is an address to further information that is accessible to be derived via computer network. A footprint includes the geo code of the geographical position associated therewith and has an icon assigned thereto. This system requires intensive communication between the laptop and the service server, adding to the cost of operation and rendring the system inoperable when the laptop computer cannot reach the server.

Document “Evaluation of inexpensive global positioning system units to improve crash location data”, A. J. Graettinger et al, Transportations Research Record 2001, nr. 1746, pages 94-101, discloses a project in which the accuracy of relatively cheap hand held and laptop GPS units for determining traffic accident locations was tested. The geographic data collected by the laptop and handheld GPS units was collected in a computer terminal and the collected data was displayed on a roadmap on the display of the computer terminal.

### DISCLOSURE OF THE INVENTION

On this background, it is an object of the present invention to provide a method for creating a collection of selected geographical positions, that is easier to use than the prior art systems. This object is achieved in accordance with claim 1 by providing a method for creating a collection of selected geographical positions using a hand portable mobile terminal (1) having a geographical position system, a display and a memory for containing the collection of selected geographical positions, comprising the steps of:
obtaining or determining the current geographical position of the mobile terminal;
assigning a name to the current geographical position of the mobile terminal;
assigning a category to the current geographical position of the mobile terminal; and
storing the obtained position in the memory upon a user input to create a collection of selected geographical positions in the memory.

Thus, the user can in a device that he/she can carry along practically anywhere add a current geographical position of interest (at least of interest to the user) to the collection of geographical positions by the press of a button whilst being located at the position of interest. There is no need to be in connection with a server or remote device. The hand portable terminal automatically prompts for a name and label to be associated with the stored geographical position. The user will thus not forget to assign name and category to the stored positions. This ensures that a subsequent search and/or analysis of the collected geographical positions is substantially facilitated.

The mobile terminal may comprise at least one key whereby the user input to save the current position is carried out by pressing the at least one key.

The mobile terminal preferably has a plurality of operating modes including one recording mode in which pressing the at least one key causes the current geographical position to be saved to the memory. Thus, the user merely has to carry out a single key depression to register a new geographical position of interest.

The mobile terminal may have means for performing mathematical operations, whereby the method further comprises the step of performing statistical and/or probability analysis on the collection of geographical positions. The mathematical analysis preferably comprise determinations of area related density of geographical positions, preferably selectively within geographical positions with a given attribute or with attributes within a given group. Thus, areas with a particularly high density of geographical position with a given type of attribute can be determined, e.g. to facilitate avoidance of the geographical locations concerned.

The mobile terminal can be provided with means for communicating geographical position data to other terminals, whereby the method further comprises the step of the mobile terminal sending geographical positions stored in the memory to other terminals and/or receiving geographical positions from other terminals. Thus, a plurality of users can share geographical positions of interest and build up a useful collection more rapidly.

The mobile terminal can have an RF or IR receiver/transmitter (e.g. Bluetooth), whereby the method further comprises the step of sending and/or receiving selected geographical positions via an RF or IR based communication channel. Thus, the geographical positions can be exchanged without the need for a cable link.

The mobile terminal can be a mobile phone or a communicator for use in a wireless cellular communication network and capable of sending and receiving text messages, whereby the method further comprises the step of sending a text message including at least one geographical position from the memory, preferably including any associated attribute of the geographical position concerned, to one or more remote terminals. Thus, the geographical positions can be exchanged between remote users via a communication channel of the cellular network. The remote terminals can be mobile phones or communicators, and one of the mobile phones or communicators may function as a server with a database of geographical positions. Thus, a larger collection of geographical positions can be created more rapidly.

The method may employ a server having a database that is connected to the cellular network and contains geographical positions received from remote terminals. Thus, a large database can be created which can be used by dedicated groups of users that need a large amount of geographical position data.

The method may further comprise the step of generating a map for illustrating the result of the statistical and/or probability analysis, preferably by generating and displaying a map of an area with a given density or density range of geographical positions with a given attribute or with attributes within a given group. Thus, the information contained in the collection of geographical positions can be visualized.

The attributes that can be attached to a geographical position can comprise a time and date stamp and/or a sound file, and/or an image file, and or a motion video file, and/or a text file.

It is yet another object of the present invention to provide a hand portable mobile terminal that enables users to create a collection of geographical positions in a user friendly manner. This object is achieved in accordance with claim 14 by providing a hand portable mobile terminal comprising means for determining a current geographical position of the mobile terminal, said mobile terminal comprising:
a processor;
a memory for storing selected geographical positions, a user interface including a number of keys and a display;
said terminal being able to assume a recording mode;
said processor being configured to store a present geographical position in said memory when a predetermined key of the mobile terminal is pressed in the recording mode; and
said processor being configured to prompt the user upon storing a geographical position to assign a name and a category to a stored position.

Thus, a current geographical location that has a user's interest can readily be stored in the mobile terminal. There is no need to be in connection with a server or remote device. The hand portable terminal automatically prompts for a name and label to be associated with the stored geographical position. The user will thus not forget to assign name and category to the stored positions. This ensures that a subsequent search and/or analysis of the collected geographical positions is substantially facilitated.

The mobile terminal may further comprise means for performing statistical and/or probability analysis on the geographical positions. This allows the user to derive further information from a larger collection of geographical positions.

The mobile terminal can also comprise a graphical display and means for generating and displaying a map with selected geographical positions from the memory. Thus, the collection of geographical data or a selection thereof through a mathematical analysis can be visualized.

The mobile terminal may further comprise an RF or IR transmitter/receiver for sending geographical positions from the memory to other terminals or receiving geographical positions from other terminals, so that geographical position data can be exchanged between terminals without a cable connection.

The mobile terminal can be a mobile phone or a communicator for use in a wireless cellular communication network that comprises means for sending and receiving text messages that include at least one geographical position, and preferably include any attribute associated with the geographical position concerned. Thus, the geographical positions can be exchanged between remote users via a communication channel of the cellular network.

The means for storing a current geographical position in the memory upon a user input can be a software application on the mobile terminal, preferably a downloadable application.

The mobile terminal may further comprise means for generating and displaying maps for visualizing the result of the statistical and/or probability analysis.

It is yet another object of the invention to provide an application for creating a collection of selected geographical positions on a hand portable mobile terminal.

This object is achieved in accordance with claim 22 by providing an application, preferably a downloadable application, for creating a collection of selected geographical positions on a hand portable mobile terminal having a geographical position system and a memory for containing the collection of selected geographical positions, the application comprising means for obtaining or determining the current geographical position of the hand portable mobile terminal and means for storing the obtained position in the memory upon a user input; means for prompting the user to assign a name to the stored geographical position of the mobile terminal; and means for prompting the user to assign a category to the stored geographical position of the mobile terminal to create a collection of selected, labeled and categorized graphical positions in the memory.

Thus, an application is provided that offers the advantages of the method and hand portable mobile terminal described above.

Further objects, features, advantages and properties of the method, the mobile terminal and the application for collecting geographical positions, according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 illustrates a preferred embodiment of a mobile terminal according to the invention,

FIG. 2 shows a block diagram of the mobile terminal of the embodiment of FIG. 1,

FIG. 3 outlines a software flow diagram for collecting geographical positions of interest with a mobile terminal according to the invention,

FIGS. 4.1 to 4.4 illustrate displays of the mobile terminal according to the invention while collecting geographical positions of interest,

FIG. 5 outlines a software flow diagram for searching and/or analyzing the collected geographical positions,

FIGS. 6.1 to 6.6 illustrate displays of the mobile terminal according to the invention while analyzing collected geographical positions of interest, and

FIG. 7 outlines a software flow diagram for exchanging collected geographical positions of interest within a group of users.

### DETAILED DESCRIPTION

The following detailed description, illustrates the mobile terminal according to the invention in the form of a hand portable phone, preferably a cellular/mobile phone. The invention can however also be carried out with any other mobile terminal having some form of positioning system and means for storing data, such as personal digital assistants (PDA) or GPS navigation terminals.

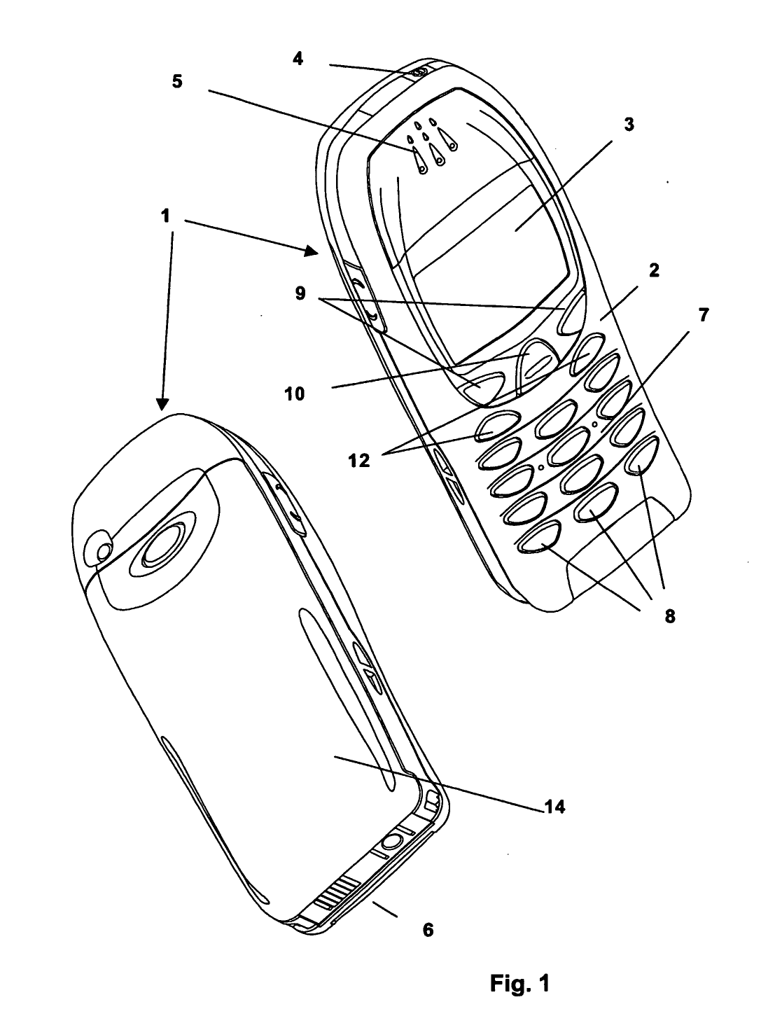

FIG. 1 shows a mobile phone according to the invention. The phone 1 comprises a user interface having a keypad 2, a display 3, an on/off button 4, a speaker 5 (only the openings are shown), and a microphone 6 (only the opening is shown). The phone 1 according to the preferred embodiment is adapted for communication via a cellular network, such as the GSM 900/1800 MHz network.

The keypad 2 has a first group 7 of keys 8 as alphanumeric keys, by means of which the user can enter a telephone number, write a text message (SMS), write a name (associated with the phone number), etc. Each of the twelve alphanumeric keys 8 is provided with a figure “0-9“or a sign “#” or “★”, respectively. In alpha mode each key is associated with a number of letters and special signs used in the text editing.

The keypad 2 has additionally a second group of keys comprising two soft-keys 9, two call handling keys 12, and an arrow key 10. The function of the soft-keys depends on the state of the phone and navigation in the menu can be performed by using the navigation-key. The present function of the softkeys 9 is shown in separate fields in the display 3, just above keys 9. The two call handling keys 12 are used for establishing a call or a conference call, terminating a call or rejecting an incoming call. This key layout is characteristic for e.g. the Nokia 6210™ phone.

The arrow key 10 is an up/down key which can be used for cursor movement and scrolling and is placed centrally on the front surface of the phone between the display 3 and the group of alphanumeric keys 7. A battery pack 14 is mounted on the back of the phone and supplies electrical power for the electronic components of the mobile phone. The phone has a flat display 3 that is typically made of a LCD with optional back lighting, such as a TFT matrix capable of displaying color images.

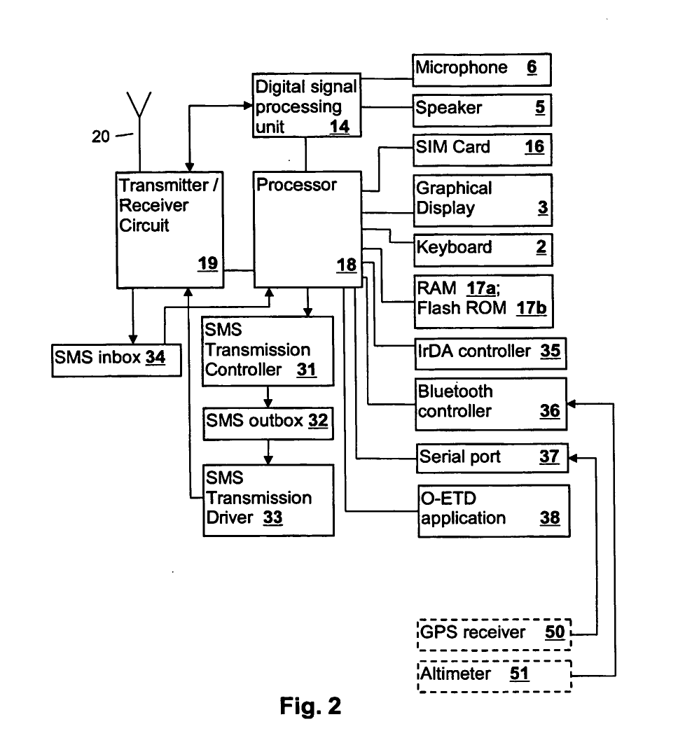

FIG. 2 schematically shows the most important parts of a preferred embodiment of the phone, in the form of a block diagram. A processor 18 controls the communication with the cellular network via the transmitter/receiver circuit 19 and an internal antenna 20. A microphone 6 transforms the user's speech into analogue signals, the analogue signals formed thereby are A/D converted in an A/D converter (not shown) before the speech is encoded in a digital signal processing unit 14 (DSP). The encoded speech signal is transferred to the processor 18, which i.e. supports the GSM terminal software. The processor 18 also forms the interface to the peripheral units of the apparatus, including a RAM memory 17a and a Flash ROM memory 17b, a SIM card 16, the display 3, the IrDA controller 35, the Bluetooth controller 36, the serial port 37 and the keypad 2 (as well as data, power supply, etc.). The digital signal-processing unit 14 speech-decodes the signal, which is transferred from the processor 18 to the earpiece 5 via a D/A converter (not shown).

As an alternative, or a supplement to the E-OTD application a GPS receiver 51 and/or a barometric altimeter 51 can be connected via cable to the serial port 37, via RF to the Bluetooth controller 36 or via IR to the IrDA controller 35. It is of course also possible to use a phone having an inbuilt GPS receiver and/or barometric altimeter.

The phone main control circuit, includes the processor 18 (can be implemented as several micro-controllers) and blocks 30-33 for controlling transmission of geographical positions as text messages according to the present invention. The blocks 30-33 can be interpreted as a data processing unit of the terminal, which can be formed in full by programming the processor 18 and their functionality is described in detail below.

The processor serves also as an interface for an E-OTD application 38 for determining the current geographical position of the mobile phone 1. E-OTD relies upon measuring the time at which signals from a base station arrive at two geographically dispersed locations—the MP itself—and a fixed measuring point known as the Location Measurement Unit (LMU) whose location is known. The geographical position of the mobile phone is determined by comparing the time differences between the two sets of timing measurements. To obtain accurate triangulation, OTD measurements are needed from at least three geographically distinct base stations. Based on the measured values, the geographical location of the phone can be calculated either by the cellular network (E-OTD stage 1) or in the phone itself, if all the needed information is available in the phone (E-OTD stage 2). For the present invention it is advantageous that the E-OTD calculation is performed on the phone in order to reduce the overall amount of messages that need to be transmitted via the cellular network, and therefore it is assumed for the embodiments described below that the position calculation is performed by the phone itself. The invention can of course also be carried out using E-OTD stage 1.

The details of the E-ODT system are as such well known to the skilled person, from e.g. GSM 03.71 version 7.3.0 Release 1998, ETSI TS 101 724 V7.3.0 (2000-02), Technical Specification Digital cellular telecommunications system (Phase 2+); Location Services (LCS); (Functional description)—Stage 2, hereby incorporated by reference.

The phone may also comprise software and/or hardware enabling it to use other techniques for automatic determination of its geographical position such as the Global Positioning System (GPS) using signals received from orbital satellites, or other cellular network based techniques such as Time of Arrival (TOA), cell of origin (COO), or time difference of arrival (TDOA), the details of which are all well-known to the skilled person.

In the following the operation of the phone will be discussed with focus on the collection of geographic positions and the exchange of geographic positions between phones.

Collecting Geographical Positions

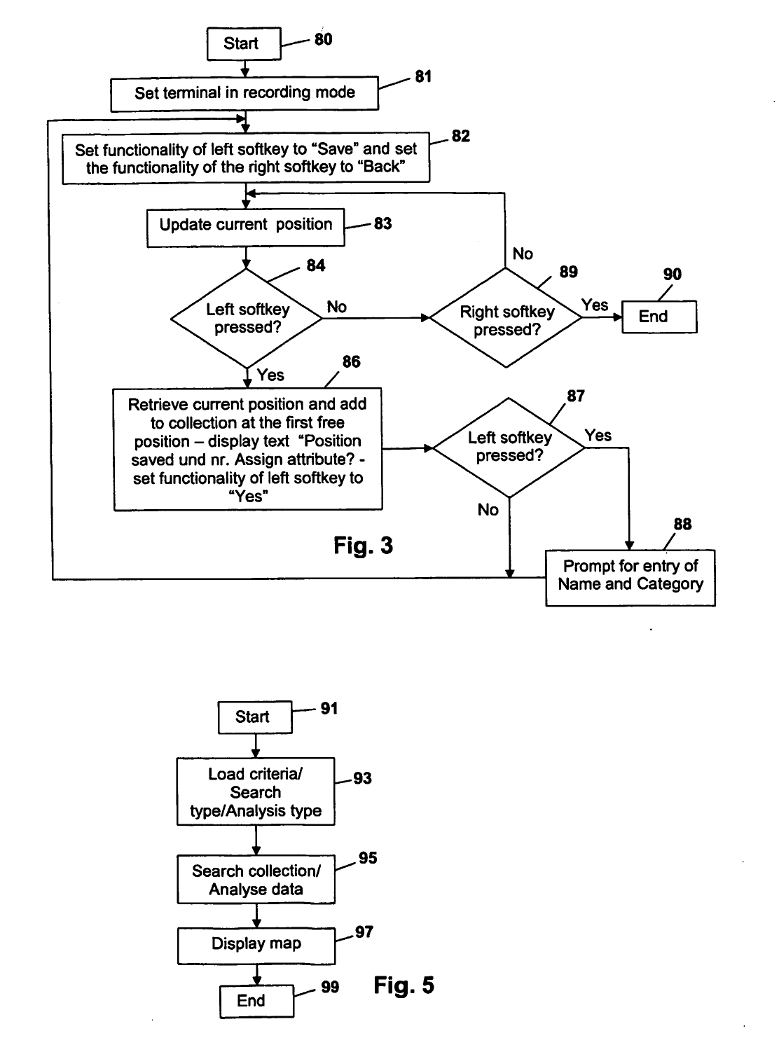

FIG. 3 outlines the software flow diagram for the part of the application for collecting geographical locations of interest. The application is preferably a Java midlet and can be downloaded from a server or preinstalled during production.

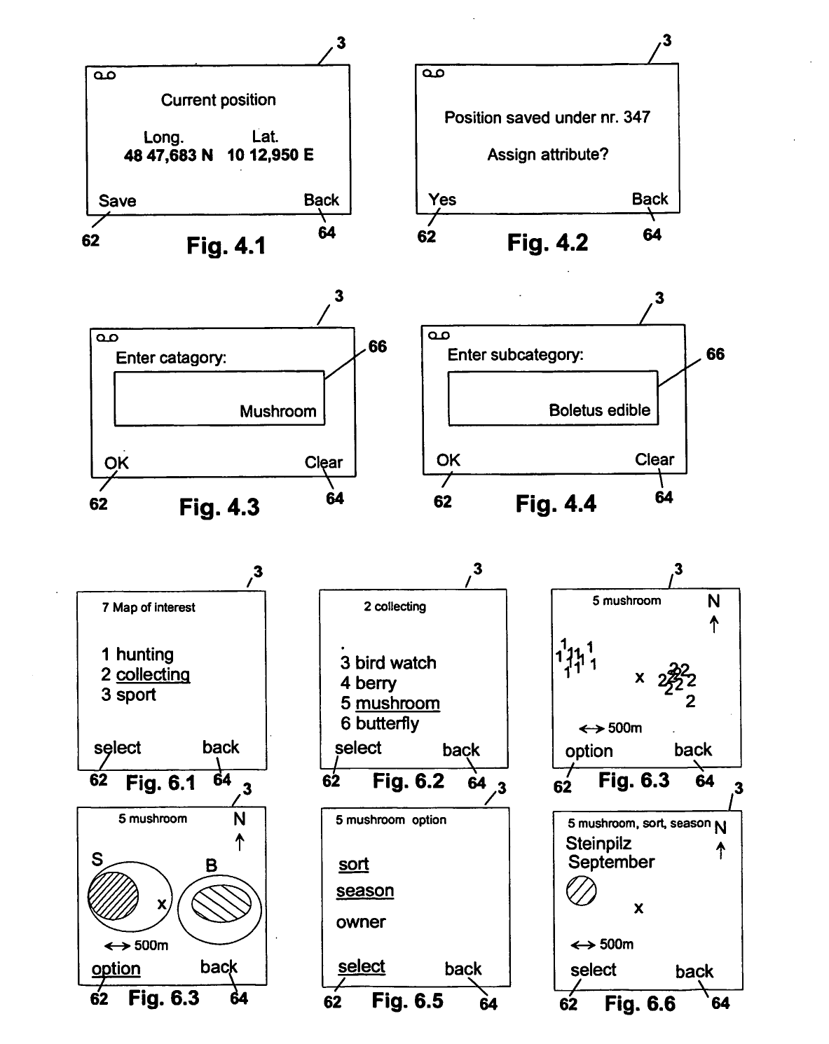

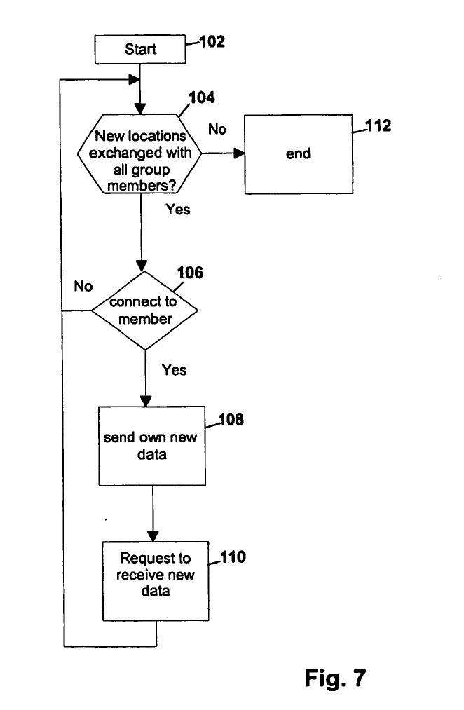

The procedure is further illustrated with the displays of FIGS. 4.1 to 4.4. The flow from start 80 to end 90 is performed several times a second in a standard polling process of the processor 18.

At the initialization step at block 81, the phone is set in the recording mode. The display indicates the present mode by displaying a recording icon and the text “Current position” above a digital indication of the current position in latitude and longitude (FIG. 4.1). In block 82, the functionality 62 of the left softkey 9 is set to “Save” and the functionality 64 of the right softkey is set to “Back”.

The current position is updated (E-OTD, GPS, TOA or any other available technique) in block 83. The status of the left softkey 9 is checked in block 84. If the left softkey 9 is pressed, the current position is retrieved and added at the first free memory position to the collection on the RAM 17a (or on the SIM card 16 if the user wishes so) in block 86. Further, in block 86 the text “Position saved under nr. . . . ” and “Assign category?” is displayed and the functionality of the left softkey 9 is set to “Yes” (FIG. 4.2). The MSISDN (phone number), the accuracy, the source of the geographical position data (E-OTD, GPS, COO, TOA etc.) and the date and time are automatically saved together with the coordinates (longitude, latitude and altitude (if available)).

The status of the left softkey 9 is checked in block 87. If the left softkey is pressed, the software prompts first for the entry of a name for the geographical position and next for a category and subcategory or subcatagories for the geographical position by displaying an input box 66 in box 88. The functionality of the left softkey is set to “OK”. (FIGS. 4.3 and 4.4). Other attributes such as a path to an image or sound file or an URL to a website can also be saved with the geographical position (this detail of the process is not shown in FIG. 3). After the entry of the name and the category (and subcategory or subcategories), or if the left softkey 9 was not pressed in block 87, the application goes to block 82 to reset the functionality 62,64 of the softkeys.

If the left softkey 9 is not pressed in box 84 the status of the right softkey is checked in box 89. If the right softkey is pressed, the process ends at block 90 until the application is polled again. If the check for the left softkey 9 is negative in block 89, the application goes to step 83 and the above process repeats itself.

Geographical Position Record Format

The geographical positions are according to a preferred embodiment saved in a the following format:

ApplID; Geo position; owner id; time; date; attribute; sub attribute; . . . (n×sub)attribute;

The content of such a record could e.g. be:

7,2,5; N12,20,14 E01,05,02; +491731233454; 13:10; 22.11.2001; 2; 5; 1; . . .

where:

2; stands e.g. for the category: collecting

5; stands e.g. for the subcategory: mushroom

1; stands e.g. for the subcategory: Steinpilz

According to another preferred embodiment of the invention the position records are saved in a similar format that allows further information to be added to the geographical position:

<position-id-part> ::=

| | |
|---|---|
| <origin-MSISDN> | ;‘phone that recorded the position’ |

<position-part> ::=

| | |
|---|---|
| <coordinate-part> | ; ‘related to coordinate and acquisition date’ |
| <extra-info-part> | ; ‘additional info’ |
| <coordinate-part> ::= | |

| | |
|---|---|
| <coordinate> | ; ‘coordinates in WGS84’ |
| <name>? | ; ‘name of the position’ |
| <accuracy> | ; ‘coordinate accuracy’ |
| <date> | ; ‘date and time of the acquisition’ |
| <source> | ; ‘location source, e.g. GPS, network, E-OTD, map’ |

<extra-info-part> ::=

| | |
|---|---|
| <category-field> | :‘category and subcategories associated to the position’ |
| <URL-field> | ; ‘URL associated to the position’ |
| <bitmap-field> | ;‘URL or path to bitmap associated with the position’ |

Analyzing the Collection of Geographical Positions

FIG. 5 outlines the software flow diagram for the part of the application that allows searching the collection and/or analyzing the data in the collection by statistical and probability methods according to user specified criteria.

The flow of the process is from the start in box 91 to the end in box 99. The criteria and the search type or the analysis type are loaded in step 93. By way of example the loading of the search criteria is illustrated with views of the display 3 in FIGS. 6.1 to 6.6. From the main menu of the phone the submenu “Map of interest” has already been selected (FIG. 6.1) and the display shows a list of selectable menu items: 1 hunting, 2 collecting and 3 sport.

By pressing the arrow key 10 down once and pressing the left softkey 9 “select”, the “2 collecting” submenu is entered and a list of selectable menu items comprising: 3 bird watch, 4 berry, 5 mushroom and 6 butterfly is displayed (FIG. 6.2).

By pressing the arrow key 10 down four times and pressing the left softkey 9 “select” a map showing an overview of the collected geographical positions with the attributes “collecting” and “mushroom” is generated (FIG. 6.3). A view like FIG. 6.3 requires a high resolution display, and the map can alternatively be displayed as shown in FIG. 6.4 for low resolution displays.

In both cases the map indicates the current location of the phone, indicates where north is and indicates the scale of the map. The functionality 62 of the left softkey 9 has changed to “options” and by pressing it the options menu lists the selectable items: sort, season and owner. By pressing the arrow down key 10 down while holding the left softkey 9 “select” down the search subcriteria “sort” and “season” are selected. The application prompts for the input of a sort and a season (not shown), and after the user has entered the desired sort and season the application searches the collection for geographic positions with the attributes that satisfy the loaded criteria in block 95.

In block 97 a map showing an overview of the collected geographical positions with the attributes collecting, mushroom, sort: “Steinpilz” and season “September” is generated (FIG. 6.6). The process ends at block 99 until the application is polled again.

The collection can be downloaded (and uploaded afterwards) on a PC or laptop computer with a similar software application to search, analyze and display maps. The collection could be downloaded via a data cable connected to the serial port 37. The software application on the PC can display a high resolution interactive map, which allows e.g. clicking onto a position to retrieve the data associated with the geographical position.

Sending a Geographical Position

When the user enters a command to send a geographical position, the processor 18 forms a position message including a standard message header, and the content of the message data line has a sequence of characters forming an identifier at the beginning of the line followed by a sequence of bits representing the geographical position including the longitude, latitude, position name, and position attributes.

The processor 18 comprises character transformation functions, which have been implemented as software, and by means of which the processor 18 processes the characters.

The processor 18 transfers the line of characters formed to an SMS transmission controller 31, which adds to the message header including message address information, i.e., the information on the destination on the basis of the user input information. The transformation of the profile and its geographical positions and their respective attributes into characters is preferably implemented as an application program that is run by the processor 18.

When the address information has been added at the SMS transmission controller 31, the position message is transferred into an outbox 32, which sends the message, and which has access to a buffer, in which the message is stored until a successful transmission has been reported. If the transmission fails, the outbox 32 re-transmits the message. When the transmitter/receiver circuit 19 has network coverage and is idle, the message is transferred to an SMS transmission driver circuit 33 by the controller 18 which adds the header to the message information relating to the mobile communications system in question, such as validity information (which indicates in which direction the message is going, i.e., from a mobile station to a message service centre or vice versa), processes the address information into a form required by the mobile communications system, and adds to the message the address of the message service centre, as well as the short message identifier, and forms the information to be transmitted, e.g., a digital signal for a transmitter 19.

Syntax of the Position Transmission

The syntax of the position transmission message is based on delimited presentation. The content is according to a preferred embodiment formatted as follows:

<position-message> ::=

| | |
|---|---|
| <position-header-part> | ; define sender/receiver and message nature |
| <position-id-part> | ; identify service |
| <position-part>* | ; information of one or several positions |

<position-header-part> ::= <message-type>“:”<location-type> line-feed>

| <message-type> ::= <message-keyword> \| <request-keyword> \| <response-keyword> | |
|---|---|
| <message-keyword> ::= 1 | ; ‘message from mobile to mobile or server to mobile’ |

| | |
|---|---|
| <position-type> ::= | <current-keyword> \| <position-keyword> |

| | |
|---|---|
| <current-keyword> ::= 1 | ; ‘current location of a mobile’ |
| <position-keyword> ::= 2 | ; ‘exchanging stored positions’ |

<position-id-part> ::=

| | |
|---|---|
| <origin- MSISDN >?, | ; phone or network app sending message |
| <target- MSISDN >? | ; final destination of message |
| <position name> | ; name of position |
| <user-text>? | ; free text entered by user |

<position-part> ::=

| | |
|---|---|
| <position-field> | ; beginning of position indicator |
| <coordinate-part> | ; related to coordinate, acquisition source and date of |
| calculation | |
| <geocode-part>? | ; address in text |
| <extra-info-part>? | ; additional info |

<coordinate-part> ::=

| | |
|---|---|
| <coordinate> | ; ‘coordinates in WGS84’ |
| <name>? | ; ‘name of the position |
| <accuracy>? | ; ‘coordinate accuracy |
| <date> ? | ; ‘date and time of the calculation’ |
| <source>? | ; ‘location source, e.g. GPS, network, E-OTD’ |
| <Position of MSISDN>? | ; MSISDN associated to the position’ |

<geocode-part> ::=

| | |
|---|---|
| <street-name-field>? | ; ‘street name’ |
| <street-number-field>? | ; ‘street address number’ |
| <zip-field>? | ; ‘zip or postal number’ |
| <town-field>? | ; ‘town name’ |
| <state-field>? | ; ‘state or province name’ |
| <country-field>? | ; ‘country name’ |
| <building-name-field>? | ; ‘Name of the building’ |
| <building-floor-field>? | ; ‘Building floor’ |
| <district-field>? | ; ‘Name of the district’ |

<extra-info-part> ::=

| | |
|---|---|
| <url-field>? | ; ‘URL associated to the position’ |
| <bitmap-field>? | ; URL of bitmap associated to the position’ |
| <category-field>?c | ; category and sub categories associated to the position |

| <latitude-field> ::= | | {“N”\|“S”} <common-digit>+[“.” <common- |
|---|---|---|
| | | digit>+][“.”<common-digit>+][“.” <common-digit>*] |
| <longitude-field> ::= | | {“W”\|“E”} <common-digit>+[“.” <common- |
| | | digit>+][“.”<common-digit>+][“.” <common-digit>*] |
| <altitude-field> ::= | | <common-digit>* |
| <accuracy-field> ::= | ac: | <default-char-not-lf>*<line-feed> |
| <bitmap-field> ::= | bi: | <default-char-not-lf>*<line-feed> |
| <category-field> ::= | ca: | <default-char-not-lf>*<line-feed> |
| <coordinate-field> ::= | co: | <latitude-field><space>+<longitude-field>[<space>+“A” |
| | | <altitude-field>]<line-feed> |
| <date-field> ::= | da: | <common-date><line-feed> |
| <position-field> ::= | lm: | <line-feed> |
| <name-field> ::= | na: | <default-char-not-lf>+<line-feed> |
| <origin-msisdn-field> ::= | om: | <common-phone-number><line-feed> |
| <position-of-msisdn-field> ::= | pm: | <common-phone-number><line-feed> |
| <source-field> ::= | so: | <default-char-not-lf>+<line-feed> |
| <target-msisdn-field> ::= | tm: | <common-phone-number><line-feed> |
| <url-field> ::= | ur: | <default-char-not-lf>+<line-feed> |
| <user-text-field> ::= | ut: | <default-char-not-lf>+<line-feed> |

A user can include several geographical positions and associated information in a message to other users, or to a server. A pincode check may be added to the message for avoiding misuse. The above message syntax is only an example of a possible message type for use with the present invention. Other message types such as WAP, MMS or XHTML can equally be deployed.

Exchanging a Geographical Positions in a Group

Groups of users with the same interest, e.g. sailplane pilots (soarers) can work together to build up a large collection of positions, e.g. geographical positions with good thermal ascent.

FIG. 3 outlines the software flow diagram of the part of the application for exchanging geographical locations of interest in a predetermined group. Communication between the phones of the users of the group can be in the above illustrated message format, or any other message type (WAP, MMS or XHTML).

The flow starts at block 102 and ends at block 112. At the initialization step at block 104, the application checks if a data exchange has taken place with each member of the group during the present session. If data exchange has not taken place with each of the members of the group, the application asks the user in block 106 permission to contact the mobile phone of a member of the group with which no data exchange has taken place. If the user grants permission, the mobile phone sends in block 108 a position message including all data that is new with respect to the last data exchange with the group member concerned. The position message also includes a request to receive all new position data that the group member concerned has collected since the last data exchange. After the data from the group member is received the application returns to block 104 to check if there is any further group members to contact, and the process above is repeated until data exchange has taken place with all group members and the process ends at block 112 until the application is polled again.

### EXAMPLES OF USE

Set out below are examples of situation where users could profit from the possibility to register current geographical positions with associated attributes:

Friends

Users register whom they meet and assign attributes, such as keyed input: category, when, where or a camera image, e.g. a motor bikers typical favorite place is each Monday in Ulm on Schill Platz from 21 pm to 24 pm but only in springtime.

Boat, Surfing

Users register wind data together with geographical positions for creating a map of wind direction/power, over time. Ad hoc info of wind spots in a team/club is made available by using data with timeout.

Restaurants

Users register classification of restaurants from the point of users'0 view concerning quality, special needs, ambience as a new criteria compare to “the best of restaurant is where the most of cars stands beside”, with geographical positions.

Concert

Users register geographical positions and assign places of high concert activities in any or in specific kinds of music. The data is shared by a group on a server. A user may have only one vote a day for avoiding misuse.

Shops

Users create black lists or white lists reflecting his/her customers satisfaction.

Soaring

Pilots create statistics over a long period of time concerning chance of thermal rise in particular areas or be warned against collision in high frequented places in dependence of date and time. The data could be used for both personal use and use in a group.

Train

For personal planning to leave timely in order to compensate rush hour delays or for taking another not so high frequented connection. The users could send the collected data to a server for traffic planning.

Hiking and Jogging

Most frequented lanes are statistically tracked for providing shops and pubs with drinks. Hikers are informed of chances to meet or not to meet many people.

Radar Traps (Traffic Control)

The method according to the invention can be used not only by car drivers but also by road services for tracking the efficiency of radar positions when users assign related information to saved geographical positions and send the data to a server.

Traffic Jams

Motor tourists are warned e.g. in a map by “victims” of a traffic jam who record geographical positions and assign traffic related information to the data that is sent to other users in a group or to a server. The position of the traffic jam is automatically unmarked when traffic is flowing again through a timeout of a time stamp. The data can also be used by road condition services or road planning activities. The system is supported by an OTA server.

Dangerous Location Warning

Users experiencing geographical positions as high risk areas collect the positions and share them in a group. The collection of positions can be used by e.g. female users and also by authorities for solving security problems. Safety guards can be ordered automatically when statistical hot spots emerge.

Extraordinary Situation or Event

An extraordinary situation notice attached to a geographical position is sent to government's server. Statistical material leads to planning and/or activities.

Anglers

Fisherman collect geographical positions with attributes relating to kind of fish, date, time, location, and weather conditions for personal use or for the angler club.

Hunters

Hunters collect geographical positions with attributes relating to kind of animal, individual, time, date, weather condition and be used for maps of deer's foot pass.

Bird Watchers

Bird watchers collect geographical positions with attributes relating to kind of bird, date, time, location.

Map Updating Support

A foot path used by hikers or bikers needs to be updated from time to time. Users send location based notices concerning e.g. road condition to server. Accumulation leads to action planning for road reconstruction.

Harbors

Sailor's collect and share information relating to most useful or most frequented places in a harbor.

Representatives (e.g. Biting Dog Problems)

Postmen or representatives on tour collect positions where they encounter problems and send notes with observations attached to the recorded geographical position to a server. The server uses the notes for planning support and/or issuing warnings to other users.

Winter Season

Pedestrians or car drivers attach notes with information concerning typically bad road condition in wintertime and add these notes to a recorded geographical position that is sent to a server. Other users may receive a warning from the server informing them of the bad conditions at the recorded geographical position.

Children

Children record geographical positions of highly frequented places on their way to school, such as e.g. a swimming pool in order to plan visits to places where there is a high chance to meet other children.

Although the present invention has been described in detail for purpose of illustration, it is understood that such detail is solely for that purpose, and variations can be made therein by those skilled in the art without departing from the scope of the invention.

Thus, while the preferred embodiments of the devices and methods have been described in reference to the environment in which they were developed, they are merely illustrative of the principles of the inventions. Other embodiments and configurations may be devised without departing from the scope of the appended claims.

1. A method for creating a collection of selected geographical positions using a mobile terminal having a geographical position system and a memory for containing the collection of selected geographical positions, comprising the steps of:
obtaining or determining the current geographical position of the mobile terminal; and
storing the obtained position in the memory upon a user input.

2. A method according to claim 1, further comprising the step of adding an attribute to the saved geographical position.

3. A method according to claim 1, wherein the mobile terminal comprises at least one key and the user input is carried out by pressing the at least one key.

4. A method according to claim 1, wherein said mobile terminal has a plurality of operating modes including one recording mode in which pressing of the at least one key causes the current geographical position to be saved.

5. A method according to claim 1, wherein the mobile terminal has means for performing mathematical operations, further comprising the step of performing statistical and/or probability analysis on the collection of geographical positions.

6. A method according to claim 1, wherein the analysis preferably comprise analysis of area related density of geographical positions, preferably selectively within geographical positions with a given attribute or with attributes within a given group.

7. A method according to claim 1, wherein the mobile terminal is provided with means for communicating data to other terminals, further comprising the step of the mobile terminal sending geographical positions stored in the memory to other terminals and/or receiving geographical positions form other terminals.

8. A method according to claim 7, wherein the mobile terminal has an RF or IR receiver/transmitter, further comprising the step of sending and/or receiving geographical positions via an RF or IR based communication channel.

9. A method according to claim 8, wherein the mobile terminal is a mobile phone or a communicator for use in a wireless cellular communication network and capable of sending and receiving text messages, further comprising the step of sending a text message including at least one geographical position from the memory, preferably including any associated attribute of the geographical position concerned, to one or more remote terminals.

10. A method according to claim 9, wherein said one or more remote terminals are mobile phones or communicators, and one of the mobile phones or communicators functions as a server with a database of geographical positions.

11. A method according to claim 8, wherein a server having a database containing geographical positions received from remote terminals is connected to the cellular network.

12. A method according to claim 5, further comprising the step of generating a map for illustrating the result of the statistical and/or probability analysis, preferably by generating and displaying a map of an area with a given density or density range of geographical positions with a given attribute or with attributes within a given group.

13. A method according to claim 1, wherein the attribute comprises a time and date stamp and/or a sound file, and/or an image file, and or a motion video file, and/or a text file.

14. A mobile terminal comprising means for obtaining or determining a current geographical position, a memory for storing selected geographical positions, a user interface and means for storing a current geographical position in the memory upon a user input.

15. A mobile terminal according to claim 14, further comprising means for adding an attribute to the saved geographical position.

16. A mobile terminal according to claim 14, further comprising a key that in at least one operational mode of the mobile terminal has the functionality of saving the current geographical position to the memory, preferably with a single depression of the key.

17. A mobile terminal according to claim 15, further comprising means for performing statistical and/or probability analysis on the geographical positions.

18. A mobile terminal according to claim 17, further comprising a display and means for generating and displaying a map with selected geographical positions from the memory.

19. A mobile terminal according to claim 14, further comprising an RF or IR transmitter/receiver for sending geographical positions from the memory to other terminals to other terminals or receiving geographical positions from other terminals.

20. A mobile terminal according to claim 14, the mobile terminal being a mobile phone or a communicator for use in a wireless cellular communication network and comprising means for sending and receiving text messages that include at least one geographical position, and preferably include any attribute associated with the geographical position concerned.

21. A mobile terminal according to claim 14, wherein the means for storing a current geographical position in the memory upon a user input is a software application on the mobile terminal.

22. A mobile terminal according to claim 17, further comprising means for of generating and displaying maps illustrating the result of the statistical and/or probability analysis.

23. An application, preferably a downloadable for creating a collection of selected geographical positions on a mobile terminal having a geographical position system and a memory for containing the collection of selected geographical positions, the application comprising:
means for obtaining or determining the current geographical position of the mobile terminal; and means for storing the obtained position in the memory upon a user input.
